(19) United States
(12) Patent Application Publication
(10) Pub. No.: US 2025/0209721 A1
(43) Pub. Date: Jun. 26, 2025

(54) HYBRID HASH FUNCTION FOR ACCESS LOCALITY

(71) Applicants: Advanced Micro Devices, Inc., Santa Clara, CA (US); ATI Technologies ULC, Markham (CA)

(72) Inventors: Michal Adam Wozniak, Santa Clara, CA (US); Guennadi Riguer, Markham (CA)

(73) Assignees: Advanced Micro Devices, Inc., Santa Clara, CA (US); ATI Technologies ULC, Markham (CA)

(21) Appl. No.: 18/390,876

(22) Filed: Dec. 20, 2023

(51) Int. Cl. G06T 15/04; G06T 15/80

(52) U.S. Cl. CPC G06T 15/04; G06T 15/80

(57) ABSTRACT

A technique for rendering is provided. The technique includes mapping a randomization portion of an item of identifying information to a random block of an address space; mapping a linear portion of the item of identifying information to an element within the block; and accessing the element.

### BACKGROUND

Three-dimensional graphics processing involves rendering three-dimensional scenes by converting models specified in a three-dimensional coordinate system to pixel colors for an output image. Improvements to three-dimensional graphics processing are constantly being made.

### BRIEF DESCRIPTION OF THE DRAWINGS

A more detailed understanding may be had from the following description, given by way of example in conjunction with the accompanying drawings wherein:

FIG. 1 is a block diagram of an example computing device in which one or more features of the disclosure can be implemented;

FIG. 2 illustrates details of the device of FIG. 1 and an accelerated processing device, according to an example;

FIG. 3 is a block diagram showing additional details of the graphics processing pipeline illustrated in FIG. 2;

FIG. 4 illustrates a set of decoupled shading operations, according to an example;

FIG. 5 illustrates operations for the visibility pass and texture marking operations, according to an example;

FIG. 6 illustrates example shade space shading operations for the shade space shading operations of FIG. 4;

FIG. 7 illustrates an example reconstruction operation;

FIG. 8 illustrates an example scene illustrating objects associated with a shade space texture;

FIG. 9 illustrates operations for accessing the tiles, according to an example;

FIG. 10 illustrates a scheme for mapping identifying information to memory addresses, according to an example; and

FIG. 11 is a flow diagram of a method for accessing data of a data structure, according to an example.

### DETAILED DESCRIPTION

A technique for rendering is provided. The technique includes mapping a randomization portion of an item of identifying information to a random block of an address space; mapping a linear portion of the item of identifying information to an element within the block; and accessing the element.

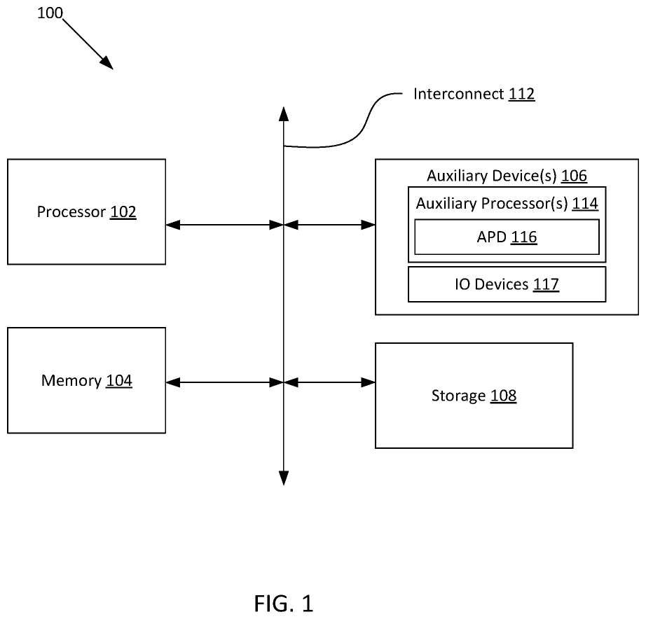

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more auxiliary devices 106 includes an accelerated processing device (“APD”) 116. The APD 116 may be coupled to a display device, which, in some examples, is a physical display device or a simulated device that uses a remote display protocol to show output. The APD 116 is configured to accept compute commands and/or graphics rendering commands from processor 102, to process those compute and graphics rendering commands, and, in some implementations, to provide pixel output to a display device for display. As described in further detail below, the APD 116 includes one or more parallel processing units configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and, optionally, configured to provide graphical output to a display device. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm perform the functionality described herein.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

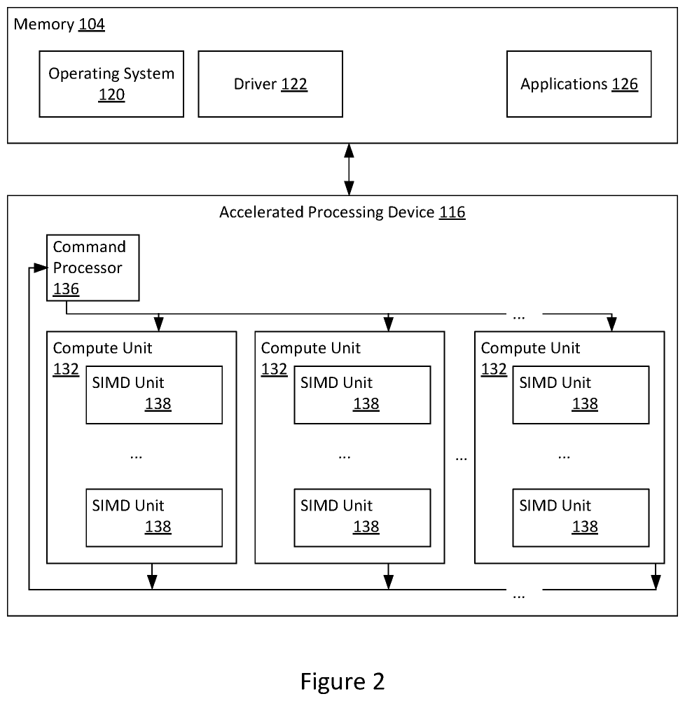

FIG. 2 illustrates details of the device 100 and the APD 116, according to an example. The processor 102 (FIG. 1) executes an operating system 120, a driver 122 (“APD driver 122”), and applications 126, and may also execute other software alternatively or additionally. The operating system 120 controls various aspects of the device 100, such as managing hardware resources, processing service requests, scheduling and controlling process execution, and performing other operations. The APD driver 122 controls operation of the APD 116, sending tasks such as graphics rendering tasks or other work to the APD 116 for processing. The APD driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to a display device based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that are configured to perform operations at the request of the processor 102 (or another unit) in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously (or partially simultaneously and partially sequentially) as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed on a single SIMD unit 138 or on different SIMD units 138. Wavefronts can be thought of as the largest collection of work-items that can be executed simultaneously (or pseudo-simultaneously) on a single SIMD unit 138. “Pseudo-simultaneous” execution occurs in the case of a wavefront that is larger than the number of lanes in a SIMD unit 138. In such a situation, wavefronts are executed over multiple cycles, with different collections of the work-items being executed in different cycles. A command processor 136 is configured to perform operations related to scheduling various workgroups and wavefronts on compute units 132 and SIMD units 138.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

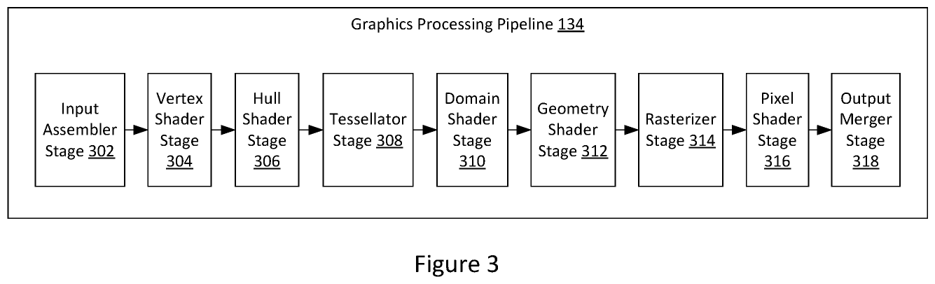

FIG. 3 is a block diagram showing additional details of the graphics processing pipeline 134 illustrated in FIG. 2. The graphics processing pipeline 134 includes stages that each performs specific functionality of the graphics processing pipeline 134. Each stage is implemented partially or fully as shader programs executing in the programmable compute units 132, or partially or fully as fixed-function, non-programmable hardware external to the compute units 132.

The input assembler stage 302 reads primitive data from user-filled buffers (e.g., buffers filled at the request of software executed by the processor 102, such as an application 126) and assembles the data into primitives for use by the remainder of the pipeline. The input assembler stage 302 can generate different types of primitives based on the primitive data included in the user-filled buffers. The input assembler stage 302 formats the assembled primitives for use by the rest of the pipeline.

The vertex shader stage 304 processes vertices of the primitives assembled by the input assembler stage 302. The vertex shader stage 304 performs various per-vertex operations such as transformations, skinning, morphing, and per-vertex lighting. Transformation operations include various operations to transform the coordinates of the vertices. These operations include one or more of modeling transformations, viewing transformations, projection transformations, perspective division, and viewport transformations, which modify vertex coordinates, and other operations that modify non-coordinate attributes.

The vertex shader stage 304 is implemented partially or fully as vertex shader programs to be executed on one or more compute units 132. The vertex shader programs are provided by the processor 102 and are based on programs that are pre-written by a computer programmer. The driver 122 compiles such computer programs to generate the vertex shader programs having a format suitable for execution within the compute units 132.

The hull shader stage 306, tessellator stage 308, and domain shader stage 310 work together to implement tessellation, which converts simple primitives into more complex primitives by subdividing the primitives. The hull shader stage 306 generates a patch for the tessellation based on an input primitive. The tessellator stage 308 generates a set of samples for the patch. The domain shader stage 310 calculates vertex positions for the vertices corresponding to the samples for the patch. The hull shader stage 306 and domain shader stage 310 can be implemented as shader programs to be executed on the compute units 132, that are compiled by the driver 122 as with the vertex shader stage 304.

The geometry shader stage 312 performs vertex operations on a primitive-by-primitive basis. A variety of different types of operations can be performed by the geometry shader stage 312, including operations such as point sprite expansion, dynamic particle system operations, fur-fin generation, shadow volume generation, single pass render-to-cubemap, per-primitive material swapping, and per-primitive material setup. In some instances, a geometry shader program that is compiled by the driver 122 and that executes on the compute units 132 performs operations for the geometry shader stage 312.

The rasterizer stage 314 accepts and rasterizes simple primitives (triangles) generated upstream from the rasterizer stage 314. Rasterization consists of determining which screen pixels (or sub-pixel samples) are covered by a particular primitive. Rasterization is performed by fixed function hardware.

The pixel shader stage 316 calculates output values for screen pixels based on the primitives generated upstream and the results of rasterization. The pixel shader stage 316 may apply textures from texture memory. Operations for the pixel shader stage 316 are performed by a pixel shader program that is compiled by the driver 122 and that executes on the compute units 132.

The output merger stage 318 accepts output from the pixel shader stage 316 and merges those outputs into a frame buffer, performing operations such as z-testing and alpha blending to determine the final color for the screen pixels.

It is possible to perform rendering in a “decoupled” manner. Decoupled rendering involves decoupling sample shading operations from other operations in the pipeline such as geometry processing and actual application of the shading results to the objects of a three-dimensional scene. In “typical” rendering such as forward rendering, a rendering pipeline processes triangles, transforming the vertices of such triangles from world space to screen space, then rasterizes the triangles, generating fragments for shading by the pixel shader. The pixel shader shades such fragments and outputs visible fragments to the pixel buffer for final output. As can be seen, in such rendering operations, the rate at which pixel shading operations occur is directly related to the rate at which geometry sampling and final image generation is performed. Advantage can be gained by decoupling the rate at which shading operations occur from the sampling rate of the rendered image. Specifically, it might be possible to reduce the heavy workload of complex pixel shading operations while still generating frames at a high frame rate to reflect changes in geometry (e.g., camera position, rotation and scene geometry movement, rotation, and scaling) quickly over time.

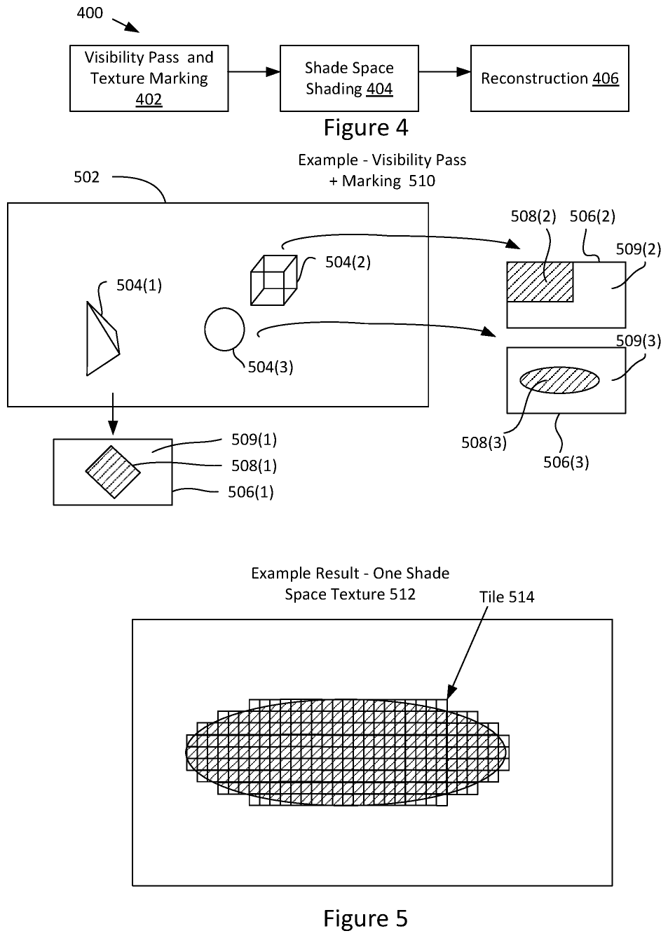

FIG. 4 illustrates a set of decoupled shading operations 400, according to an example. The set of decoupled shading operations 400 includes a visibility pass and shade space marking operation 402, a shade space shading operation 404, and a reconstruction operation 406. In some examples, any of these operations is performed by one or more of software executing on a processor (such as the compute units 132), hardware (e.g., hard-wired circuitry), or a combination of software and hardware. In various examples, any of this software includes software executing on the processor 102 (e.g., an application), software executing in the APD 116 (e.g., shader programs), any other software, or any combination thereof. In various examples, the hardware includes any of the processors illustrated (e.g., processor 102, APD 116), or other circuitry or processors not illustrated. In this disclosure, phrases such as “the APD 116 performs a task” is sometimes used. This should be understood as meaning that any technically feasible element (e.g., the software or hardware) performs such task. In addition, although various operations are described as being performed by the APD 116, in other examples, such operations are performed by other elements such as the processor 102 or another hardware or software element not described. Herein, where it is stated that software performs an operation, this should be understood as meaning that software executing on a processor performs the operation and thus that the processor performs that operation.

As a whole, the operations of FIG. 4 involve three “phases”: a visibility determination phase, a shade space texture shading phase and a reconstruction phase. The shade space texture shading phase includes shading onto shade space texture for a scene. The shade space textures can be thought of as “canvases” to which shading operations are applied. The canvases are applied to the objects of a scene in the reconstruction phase. It is possible to decouple the rate at which the shade space shading phase occurs from the rate at which the reconstruction phase occurs, providing benefits such as reduction of shading operation workload while still allowing for generating output frames at a high rate.

As described above, the objects of a scene each have one or more shade space textures. The shade space textures are mapped to the surfaces of such objects and colors in the shade space textures are applied to the objects during reconstruction 406. Utilizing the shade space textures in this manner allows for shading operations (e.g., the shade space shading operations 404) to occur in a “decoupled” manner as compared with the other rendering operations.

The visibility pass and shade space marking 402 involves marking which portions of the shade space textures are visible in a scene. In some examples, the scene is defined by a camera and objects within the scene, as well as parameters for the objects. In some examples, a portion of a shade space texture is visible in the event that the portion appears in the final scene. In some examples, the portion appears in the final scene if the portion is within the camera view, faces the camera, and is not occluded by other geometry. In some examples, the visibility pass and shade space marking operation 402 results in generating groups of samples, such as tiles, that are to be shaded in the shade space shading operation 404. Each tile is a set of texture samples of a shade space texture that is rendered into in the shade space shading operation 404 and then applied to the geometry in the reconstruction 406 operation. In some examples, each such tile is a fixed size (e.g., 8×8 texture samples or “texels”). In various examples, the visibility pass and shade space marking 402 is performed by a forward rendering pass, ray casting, or any other technically feasible technique that achieves determination of which portions of the shade space textures are visible in a scene.

The shade space shading operation 404 includes shading the visible portions of the shade space textures. In some examples, these shading operations are operations that are typically applied in the pixel shader stage 316 in “typical” rendering. Such operations include texture sampling (including filtering), applying lighting, and applying any other operations that would be performed in the pixel shader stage 316.

The reconstruction operation 406 includes applying the shade space textures to the geometry of the scene to result in a final image. In some examples, the reconstruction operation 406 processes the scene geometry through the world space pipeline, including applying the operations of the vertex shader stage 304 (e.g., vertex transforms from world-space to screen space) and the rasterizer stage 314 to generate fragments. The reconstruction operation 406 then includes applying the shade space texture to the fragments, e.g., via the pixel shader stage 316, to produce a final scene which is output via the output merger stage 318. Note that the operations of the pixel shader stage 316 in reconstruction 406 are generally much simpler and less computationally intensive than the shading operations that occur in the shade space shading operations 404. For example, while the shade space shading operations 404 perform lighting, complex texture filtering, and other operations, the reconstruction operation 406 is able to avoid many such complex pixel shading operations. In one example, the reconstruction operation 406 performs texture sampling with relatively simple filtering and omits lighting and other complex operations.

As stated above, it is possible to apply the shade space shading operation 404 at a different frequency than the reconstruction operation 406. In other words, it is possible to use the information generated by the shade space operation 404 in multiple successive reconstruction operations 406 (or reconstruction “frames”). Thus, it is possible to reduce the computational workload of the complex shading operations 404 while still generating output frames relatively quickly. The decoupled shading operations 400 will now be described in greater detail.

FIG. 5 illustrates operations for the visibility pass and shade space marking operations 402, according to an example. Herein, the term “visibility pass 402” is used interchangeably with “visibility pass and texture marking operations 402.” The example visibility pass 402 is performed for a scene 502 which includes a number of objects 504. In addition, each object 504 has an associated shade space texture 506 which has a visible portion 508 and a non-visible portion 509. As can be seen, the example visibility pass 510 results in the designation of the visible portion 508 of the associated shade space texture 506.

In an example 512, the visibility pass 402 designates the visible portions 508 of the shade space textures 506 by generating tiles 514 that cover the visible portions in the following manner. The visibility pass 402 performs the operations of the graphics processing pipeline 134 in a simplified mode. Specifically, the visibility pass 402 generates tiles for the portions of the shade space texture 506 that are visible in the scene. Each tile 514 represents a portion of the shade space texture 506 that is to be shaded in the shade space shading operation 404. Tiles that are not generated are not shaded in the shade space operation 404.

In some examples, the visibility pass 402 generates tiles by using the graphics processing pipeline 134. More specifically, the geometry of the scene 502 is processed through the graphics processing pipeline 134. Information associating each fragment with a shade space texture flows through the graphics processing pipeline 134. When the final image is generated, this information is used to identify which portions of which shade space textures 506 are actually visible. More specifically, because only visible fragments exist in the final output image, the information associated with such fragments is used to determine which portions of the shade space textures 506 are visible.

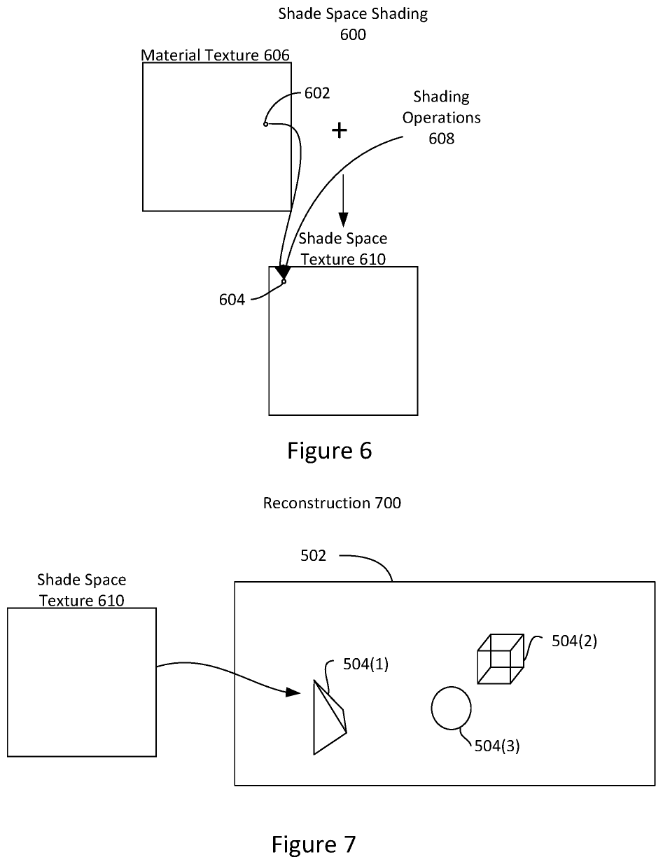

FIG. 6 illustrates example shade space shading operations 600 for the shade space shading operations 404 of FIG. 4 in accordance with a previously performed visibility determination (e.g., operation 402). The APD 116 performs shade space shading 600 by sampling a material texture 606 within a sample area 602 to obtain a texture color and applying shading operations 608 (e.g., lighting and/or other operations) as a result to generate a shade space color sample 604 for the shade space texture 610. In some examples, the shade space shading operations 600 generates texels for the entirety of each of the tiles 514 that are generated as a result of the visibility pass 402. FIG. 7 illustrates an example reconstruction operation 700. In the reconstruction operation 700, the shade space texture 610 is applied to the objects 504 within the scene. As stated elsewhere herein, in some examples, this application is performed via relatively simple texture sampling operations during rendering that sample the shade space texture 610 in a relatively simple manner and apply such samples to the objects 504 of the scene 502.

The shade space texture 610 is an important part of decoupled shading that is frequently accessed. For example, the shade space shading pass 404 involves shading the shade space texture 610, determining, for example, colors and/or other aspects for the pixels of the shade space texture 610. The reconstruction pass 406 involves using the shade space texture to generate the final output image. Due to the frequency of access, it is important to store the data of the shade space texture 610 efficiently. For example, there is a desire to be able to quickly determine where an item of data in the shade space texture 610 resides in memory based on characteristic identifiers (e.g., mesh identifier, texture coordinates, MIP level). In another example, there is a desire to store data that is likely to be accessed together close together in memory (e.g., so that cache line fetches can efficiently fetch multiple items of data). A means of storing the shade space texture 610 that satisfies these desires is thus provided herein.

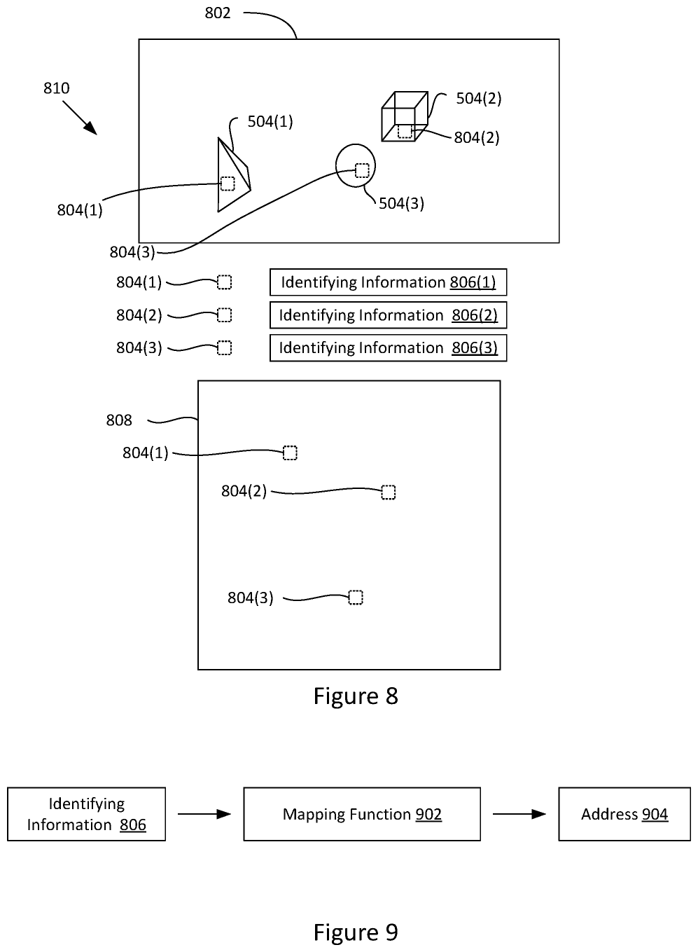

FIG. 8 is an illustration 810 of an example scene 802 illustrating objects 504 associated with a shade space texture. Also illustrated are shade space texture tiles 804 on each of these objects. These shade space texture tiles 804 represent portions of shade space textures that are actually visible in the scene 802. For example, for any given object 504, there may be surfaces on that object that do not face the camera and are thus not visible. In another example, portions of a given object 504 may be occluded by other objects. In yet another example, objects may be out of the view frustum (and thus “off camera”). In still another example, it is possible for a portion of a texture space to be represented with multiple MIP levels (levels of detail). In such an example, a limited number of such levels of detail are visible. There are many reasons why a portion of any given texture may not be visible. Thus while the shade space texture can be said to encompass such non-visible surfaces as well as the visible surfaces, the actually visible portions of the shade space texture generally includes a much lower portion of the entirety of the shade space texture.

Each tile 804 is associated with identifying information 806. The identifying information uniquely identifies the tile 804 out of an entire set 808 of possible tiles that could be generated for a scene. An example of such a set 808 is also illustrated in FIG. 8. In some examples, the tiles 804 that are included in this set 808 include all tiles that could potentially be rendered in the scene in the sense that the set 808 includes any tile that could be represented by any combination of values of the identifying information 806. As described above, in some examples, the identifying information 806 includes one or more of mesh/object identifier, texture coordinates, and MIP level. In some examples, the identifying information 806 includes one or more additional types of information and/or does not include one of the types of information mentioned herein. In some examples, the set 808 of possible tiles includes tiles for each combination of values of such identifying information 806, even if any such tile is not actually visible in the scene 802. In various examples, the visible tiles include a particular tile 804 for a particular object 504, defined by a particular MIP level and a particular set of texture coordinates. A portion of that same object corresponding to a different tile 804—for the same texture coordinates but with a different MIP level is not rendered for the scene (and is thus not “visible”). However, even though this tile 804 is not visible, it is part of the set 808 of possible tiles.

FIG. 9 illustrates operations 900 for accessing the tiles 804, according to an example. There is a need to access the tiles 804 that are actually visible during processing for the decoupled rendering. Again, such accesses include, without limitation, generating the tiles 804 in the shade space shading pass 404, and accessing the tiles 804 to render the final image. Further, at some point during decoupled rendering, the decoupled shading operations 400 perform a lookup, using the identifying information 806 to find a slot for the tile 804. In an example, the “slot” 804 is a location in memory defined at least by a beginning address. In some examples, the decoupled shading operations 400 access a visible tile 804 by performing a lookup on a data structure that is configured to store visible tiles 804, by processing the identifying information 806 using a lookup operation to obtain an address for the tile 804 and accessing the tile.

The lookup includes performing a mapping function 902, converting the identifying information 806 into an address 904. Each address 904 is a reference (e.g., address) to a tile. In various examples, the mapping function 902 is performed by any of the entities (e.g., software or hardware entities) that performs any of the decoupled shading operations 400. After the mapping, the decoupled shading operations 400 accesses the tile 804 at the given address and utilizes the accessed tile 804 in accordance with the decoupled shading operations 400 (e.g., as specified elsewhere herein).

It is important to use an efficient mapping function 902 so that references to the visible tiles 804 within a hash table have locality and can thus be accessed efficiently. To that end, it is important to consider certain issues. One issue is that although the “space” of possible identifying information values is quite large, only a small amount of such values are actually used in a given scene. This is an issue because care should be taken to avoid storing references to the visible tiles 804 in a completely non-coherent manner in the hash table, which would result in inefficient cache usage. A well-designed mapping function minimizes wasted space by mapping keys to tile references in a manner that minimizes collisions. A collision occurs in the event that two different keys that are actually in use in the hash table (e.g., two different keys for data from different tiles 804) map to the same slot in the hash table.

Hash tables frequently use pseudo-random mapping functions to disperse keys throughout the hash table, minimizing collisions. While a purely random function frequently performs well, there are other considerations for the hash table that result in a purely random function not being optimal for the tiles disclosed herein. Specifically, a purely random function that maps individual keys randomly to tile references in the hash table, even in situations where it would be beneficial to map some texels contiguously. More specifically, as stated above, the hash table has entries indexed by a key, where each entry stores a reference to a tile. Accessing the hash table requires reading the entry in memory, which involves loading that entry into a cache and then accessing the cache. As data is typically loaded into the cache in cache lines, which are larger than one entry of the hash table, such an access would load a lot of hash table entries into the cache. If there is at least some coherency in the hash table, then accessing one cache entry would bring in other entries into the cache as well, which would result in future hits in the cache instead of misses. “Coherency” in this instance means that tile references that are likely to be accessed together are stored close together in the hash table and thus would be brought into the cache together. In some examples, tiles are likely to be accessed together if they share some spatial locality in the texture space. For example, tiles that are adjacent or within a relatively small area in the shade space texture are likely to be accessed together, as it is likely that large “chunks” of such a shade space texture will be accessed. Although it is important to have coherency, it is also important to have some dispersion of tile references in order to reduce the number of collisions that occur.

For this reason, techniques are provided herein for providing a mapping function that provides effective dispersion of tile information within a hash map while also allowing for memory access locality to gain efficiencies such as those related to cache line fetching.

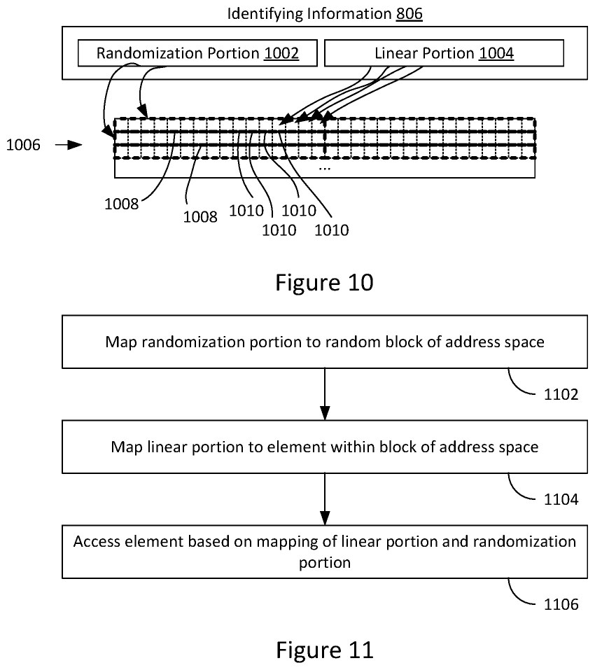

FIG. 10 illustrates a scheme for mapping identifying information 806 to memory addresses, according to an example. FIG. 10 illustrates identifying information 806 and an address space 1006. The address space 1006 is a set of memory addresses that refer to any memory, such as any memory of the device 100. In the depicted address space 1006, memory addresses increase linearly from left to right and then from top to bottom, so that a first row of the depicted address space 1006 has a first set of linearly increasing addresses, a second row of the depicted address space 1006 has a second set of linearly increasing addresses immediately after the first set, and so on. In some examples, the memory addresses are references to tiles of shade space textures.

According to this scheme for mapping, the identifying information 806 includes a randomization portion 1002 and a linear portion 1004. Additionally, according to the scheme, the randomization portion 1002 maps randomly or pseudo-randomly to a block 1008 in the address space 1006. In addition, the linear portion 1004 maps linearly to entries within a block 1008. Although it is shown that a block is aligned to some address boundary, it is not necessary for a block 1008 to be at an address boundary. Additionally, the illustrated block is stored fully sequentially in the illustrated example, but, due to collisions, it is possible for blocks to be broken up and stored at least partially non-sequentially, due to collisions that may occur differently for different entries 1010.

The randomization portion 1002 includes bits of the identifying information 806 that identify a block 1008. In some examples, a block 1008 is a chunk of the address space 1006 that has a size that is based on the number of bits in the linear portion 1004. In an example, if the linear portion includes enough bits to address 256 entries 1010, then each block 1008 has 256 entries. In some examples, each entry is a reference to a tile of a shade space texture.

Example blocks 1008 are shown. In the example, each block 1008 has 16 entries, meaning the linear portion 1004 can address up to 16 entries and thus the block size 1008 is 16 entries large. In some examples, the entire address space 1006 is divided into blocks 1008 having a size defined by the linear portion 1004 of the identifying information. Thus, a given item of identifying information 806 is mapped to a particular block 1008 and a particular entry (e.g., address) 1010 within that block 1008.

As described, the mapping function 902 maps the randomization portion 1002 randomly to a block 1008. Any technically feasible operation for performing random hash mapping could be used to map a randomization portion 1002 of the identifying portion 1002 to a block 1008. Also, the mapping function 902 maps the linear portion 1004 linearly within the block 1008 mapped to by the randomization portion 1002. In other words, the raw value of the linear portion 1004 maps directly, without modification, to an entry 1010 within a block 1008. For example, a value of 0 maps to the first entry 1010 of a block 1008, a value of 1 maps to the second entry 1010, and so on. It should be noted, however, that different entries 1010 that share the same linear portion 1004 can map to different blocks 1008 due to collisions in the hash function (a collision occurs where two different key values map to the same entry 1010 of the hash table, in which case the mapping function must find a new entry 1010 to place the value for the second key).

In some examples, the linear mapping occurs in a way that tile references that are likely to be accessed together (e.g., at the same time or in immediate sequence) are mapped to the same block 1008. In an example, the linear portion 1004 includes at least a portion of the texture coordinates for shade space tiles. Because texture coordinates of a tile 804 and its neighbors are likely to be accessed together (e.g., by the same work-item in a wavefront or in immediate sequence by the same work-item), mapping these coordinates linearly, rather than randomly, helps improve memory access locality, which can have benefits such as better cache efficiency. For example, when the cache line for one tile reference is fetched into a cache, it is likely that references for other neighboring tiles are fetched into the cache, as it is likely that those other tile references are part of the same cache line, due to locality of storage in the hash table.

In an example, the linear portion 1004 of the identifying information 806 includes the low bits of the two components of the texture coordinates (e.g., u and v coordinates). In some examples, the linear portion 1004 includes all bits of the two components of the texture coordinates. Configuring the linear portion 1004 in such a manner means that contiguous portions of tiles will tend to fall within the same block 1008. In another example, distribution of tiles in a shade space is considered in a scene specific manner to define an optimal distribution of identifying information between a linear and randomization portions.

Using a randomization portion 1002 for the remainder of the identifying information 806 assists with reducing hash function collisions. More specifically, in a hash table, a collision occurs when two different keys (e.g., two different sets of identifying information 806) are mapped to the same slot in the hash table (e.g., the same memory address). When a collision occurs for a given key, the mapping function 902 must search for an unoccupied slot in the hash table for access for the key. As such a search takes additional time, reducing collisions helps improve performance.

Mapping the randomization portion 1002 randomly or pseudo-randomly to memory addresses helps to reduce collisions while mapping the linear portions 1004 linearly within the blocks 1008 helps improve memory access locality.

It is possible for the mapping function 902 to set the size of the block 1008 based on runtime factors and/or based on information received from an application. In an example, an application that controls or requests performance of the decoupled shading operations 400 also specifies the size of the block 1008 (and thus the size of the linear portion 1004). The mapping function 902 utilizes that size in performing mapping based on the identifying information 806 as described elsewhere herein. In an example, the application controls the block size based on aspects of the content being rendered or based on other information.

In some examples, the mapping function uses a hash map with an open-addressing scheme. In some examples, an open-addressing scheme means that searches for collisions are not restricted to a particular set of memory addresses or data structure elements. In some examples, the mapping function 902, upon detecting a collision for a key at a particular address (meaning another element is stored at that address), the mapping function 902 adds a value to the address and tests for a collision at that location. If a collision occurs at that new address, then the mapping function 902 adds a new value to the new address and tests for a collision at that location. The mapping function 902 repeats this operation until no collision is detected.

Herein, it is sometimes stated that the mapping function 902 or decoupled shading operations 400 performs a certain operation. This should be understood to mean that whatever entity implements the mapping function 902 or decoupled shading operations 400 (e.g., software, hardware, such as circuitry, or any other entity such as those described elsewhere herein) perform that operation.

Herein, it is stated that a mapping function or other operation is random or pseudo-random. A random or pseudo-random function in the context of a hash table is a function that maps keys to addresses in a manner that eliminates or reduces the effect of patterns in the keys. In some examples, a random or pseudo-random function maps inputs (e.g., the randomization portion 1002) that have similar values to distant or non-contiguous addresses. In some examples, a pseudo-random function differs from mapping for the linear portion 1004 of the identifying information 806 in that the mapping for the linear portion 1004 does not “rearrange” the inputs while the pseudo-random function rearranges the inputs in an attempt to spread out the data within the hash table.

Above it is stated that the mapping function 902 maps the randomization portion 1002 to blocks 1008 in a pseudo-random manner. It is possible for an application, such as the application performing or requesting to be performed the decoupled shading operation 400, to provide data to the mapping function 902 that “hints” at how to map the randomization portion 1002 to blocks 1008. In some examples, the mapping function 902 uses this data in determining which block 1008 a given randomization portion 1002 maps to.

In some examples, the phrase “mapping a randomization portion 1002 to a block 1008” means that the mapping function 902 determines which block address within the hash table the randomization portion 1002 maps to.

FIG. 11 is a flow diagram of a method 1100 for accessing data of a data structure, according to an example. Although described with respect to the system of FIGS. 1-10, those of skill in the art would understand that any system, configured to perform the operations of the method 1100 in any technically feasible order, falls within the scope of the present disclosure.

In some examples, prior to the method, an element, such as an operation of the decoupled shading operations 400, requests access to a texel of a shade space texture. The request specifies a set of identifying information 806 that indicates, for example, texture coordinates, a MIP level, a mesh or object identifier, and/or another item of information. In response to this access, a mapping function maps the identifying information 806 to an address of the hash function. The mapping function checks for a collision at that address, and, if no collision occurs, returns the address to the requesting entity or performs the access requested at that address. If a collision occurs, then the mapping function finds a different slot within the address space, checking that slot for a collision, and so on. The method 1100 represents steps of mapping the identifying information 806 to an address containing a reference to a shade space tile information.

At step 1102, the mapping function 902 maps the randomization portion 1002 of the identifying information 806 to a block 1008 of an address space 1006. As described elsewhere herein, this mapping occurs in a random or pseudo-random manner. That is, the randomization portion 1002 maps randomly or pseudo-randomly to a block 1008. This random or pseudo-random mapping helps to reduce collisions in the hash map by reducing or eliminating the contribution of similarities in the underlying data (e.g., the values of the randomization portion 1002) to the mapping function as compared with a situation in which such randomization did not occur. In an example, if a limited number of objects are on scene, then without a randomization function, the data in the hash function could be limited to a certain number of slots, since without randomization, some slots could never be used for the objects that are actually visible in the scene. Any technically feasible randomization function could be utilized.

At step 1104, the mapping function 902 maps the linear portion 1004 to an element within the block 1008 mapped to the randomization portion 1002. Mapping the linear portion 1004 occurs in a linear manner. In other words, the mapping function 902 maps values of the linear portion 1004 to the entries 1010 of a block 1008 linearly. Such linear mapping means that for any two items of identifying information 806, if such items include the same randomization portion 1002, then any value for the linear portion 1004 will map to the same block. In some examples, mapping such values linearly means that the linear portion 1004 is treated as an offset into a block 1008. In some examples, the mapping results in a collision, in which case the mapping function 902 attempts to find a different slot.

At step 1106, an entity accesses the element based on the mapping of the linear portion and the randomization portion. In some examples, the entity is a shade space shading operation 404 and the access includes writing a texel value at the address specified by the mapping (e.g., by using the tile reference that the element to reference a tile, offset by a texel offset within the tile). In some examples, the entity is a reconstruction operation 406 and access includes reading from the address specified by the mapping in order to obtain one or more texels for performing reconstruction.

Although described with respect to the decoupled shading operations 400, it should be understood that any other entity (such as any technically feasible software or hardware (circuitry) entity) can use a hash function implementing the mapping function described herein.

It should be understood that many variations are possible based on the disclosure herein. Although features and elements are described above in particular combinations, each feature or element can be used alone without the other features and elements or in various combinations with or without other features and elements.

Each of the units illustrated in the figures represent hardware circuitry configured to perform the operations described herein, software configured to perform the operations described herein, or a combination of software and hardware configured to perform the steps described herein. For example, the processor 102, memory 104, any of the auxiliary devices 106, the storage 108, the command processor 136, compute units 132, SIMD units 138, input assembler stage 302, vertex shader stage 304, hull shader stage 306, tessellator stage 308, domain shader stage 310, geometry shader stage 312, rasterizer stage 314, pixel shader stage 316, output merger stage 318, and mapping function 902 are implemented fully in hardware, fully in software executing on processing units, or as a combination thereof. The visibility operation 402, shade space operation 404, and reconstruction operation 406 represent activity performed by a processor such as the processor 102 or APD 116. In various examples, any of the hardware described herein includes any technically feasible form of electronic circuitry hardware, such as hard-wired circuitry, programmable digital or analog processors, configurable logic gates (such as would be present in a field programmable gate array), application-specific integrated circuits, or any other technically feasible type of hardware.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method comprising:
mapping a randomization portion of an item of identifying information to a random block of an address space;
mapping a linear portion of the item of identifying information to an element within the block; and
accessing the element.

2. The method of claim 1, wherein the item of identifying information is for a tile of a shade space texture.

3. The method of claim 2, wherein the linear portion includes bits of texture coordinates of the tile.

4. The method of claim 3, further comprising performing decoupled shading operations with the element.

5. The method of claim 4, wherein the decoupled shading operations include a shade space shading operation that shades a texel of the tile.

6. The method of claim 4, wherein the decoupled shading operations include a reconstruction operation that generates a final image based on a texel of the tile.

7. The method of claim 1, wherein mapping the linear portion to the element is performed in a linear manner.

8. The method of claim 7, wherein mapping the linear portion in the linear manner includes adding a value derived from the linear portion to an address of the block.

9. The method of claim 1, further comprising performing an additional lookup in response to a collision.

10. A system comprising:
a memory configured to store an element; and
a processor configured to:
map a randomization portion of an item of identifying information to a random block of an address space;
map a linear portion of the item of identifying information to the element within the block; and
access the element.

11. The system of claim 10, wherein the item of identifying information is for a tile of a shade space texture.

12. The system of claim 11, wherein the linear portion includes bits of texture coordinates of the tile.

13. The system of claim 12, wherein the processor is further configured to perform decoupled shading operations with the element.

14. The system of claim 13, wherein the decoupled shading operations include a shade space shading operation that shades a texel of the tile.

15. The system of claim 13, wherein the decoupled shading operations include a reconstruction operation that generates a final image based on a texel of the tile.

16. The system of claim 10, wherein mapping the linear portion to the element is performed in a linear manner.

17. The system of claim 16, wherein mapping the linear portion in the linear manner includes adding a value derived from the linear portion to an address of the block.

18. The system of claim 10, wherein the processor is further configured to perform an additional lookup in response to a collision.

19. A non-transitory computer-readable medium storing instructions that, when executed by a processor, cause the processor to perform operations comprising:
mapping a randomization portion of an item of identifying information to a random block of an address space;
mapping a linear portion of the item of identifying information to an element within the block; and
accessing the element.

20. The non-transitory computer-readable medium of claim 19, wherein the item of identifying information is for a tile of a shade space texture.
